(19) United States
(12) Patent Application Publication
(10) Pub. No.: US 2017/0090107 A1
(43) Pub. Date: Mar. 30, 2017

(54) BACKLIGHT MODULE AND LIQUID CRYSTAL DISPLAY DEVICE

(71) Applicant: Shenzhen China Star Optoelectronics Technology Co., Ltd., Shenzhen, Guangdong (CN)

(72) Inventor: Yong FAN, Shenzhen, Guangdong (CN)

(73) Assignee: Shenzhen China Star Optoelectronics Technology Co., Ltd., Shenzhen, Guangdong (CN)

(21) Appl. No.: 14/778,588

(22) PCT Filed: Jul. 3, 2015
(86) PCT No.: PCT/CN2015/083244

§ 371 Date: Sep. 19, 2015

(30) Foreign Application Priority Data
May 15, 2015 (CN) 201510249342.1

(51) Int. Cl. F21V 8/00

(52) U.S. Cl. CPC G02B 6/0078; G02B 6/0051; G02B 6/0055; G02B 6/009; G02B 6/0088; G02B 6/0043

(57) ABSTRACT

The present invention provides a backlight module and a liquid crystal display device. The backlight module comprises a substrate, at least two light guide plate, a light source and a diffuser, and the light guide plates are located at the same surface of the substrate, and tilted angles are formed between the light guide plates and the substrate, and the light guide plate comprises a first lateral surface, a second lateral surface, an illuminating surface and a bottom surface, and the first lateral surface is located close to the light source to be an incident surface of the light guide plate, and the diffuser is located close to the illuminating surface of the light guide plate, and a predetermined distance is set between the diffuser and a part of the light guide plate which is closest to the diffuser adjacent thereto.

### CROSS REFERENCE

This application claims the priority of Chinese Patent Application No. 201510249342.1, entitled “Backlight module and liquid crystal display device”, filed on May 15, 2015, the disclosure of which is incorporated herein by reference in its entirety.

### FIELD OF THE INVENTION

The present invention relates to a flat panel display field, and more particularly to a backlight module and a liquid crystal display device.

### BACKGROUND OF THE INVENTION

The Liquid Crystal Display (LCD) is a common display device, and possess properties of low power consumption, small volume and light weight. Therefore, it has been favored by the users. Generally, the Liquid Crystal Display comprises a backlight module and a display panel. The backlight module is employed to provide a light source for the display panel. In common, the backlight module is a side-light type. Such kind of backlight module comprises a light guide plate and light sources located at one side or multiple sides of the light guide plate. The light emitted from the light source exist from the illuminating surface of the light guide plate after the diffusion function of the light guide plate to provide lights for the display panel. However, the intensity of the light emitted from the illuminating surface at the side close to the light source is stronger, and the intensity of the light emitted from the illuminating surface at the side away from the light source is weaker. With the large scale development requirement to the display panel of the display device, the brightness difference between the illuminating surface having stronger light and the illuminating surface having weaker light is larger. Moreover, the brightness of the light emitted from the illuminating surface having weaker light cannot satisfy the requirement of the normal display.

### SUMMARY OF THE INVENTION

The present invention provides a backlight module and the backlight module comprises a substrate, at least two light guide plate, a light source and a diffuser, and the light guide plates are located at the same surface of the substrate, and tilted angles are formed between the light guide plates and the substrate, and the light guide plate comprises a first lateral surface, a second lateral surface, an illuminating surface and a bottom surface, and the first lateral surface and the second lateral surface are oppositely located, and the illuminating surface and the bottom surface are oppositely located, and the illuminating surface and the bottom surface are respectively intersect with the first lateral surface and the second lateral surface, and the first lateral surface is located close to the light source to be an incident surface of the light guide plate, and the diffuser is located close to the illuminating surface of the light guide plate, and a predetermined distance is set between the diffuser and a part of the light guide plate which is closest to the diffuser adjacent thereto.

The backlight module further comprises a reflective sheet, and the reflective sheet is located close to the bottom surface and the second lateral surface of the light guide plate.

The backlight module further comprises a light source support part, and the light source support part is employed to support the light source, and the light source support part is located in an accommodation space formed by the light guide plate and the substrate.

The backlight module further comprises a support element, and the support element is located between the illuminating surface of the light guide plate and the diffuser, and the support element is employed to support the diffuser.

The backlight module further comprises a fixing element, and the light guide plate is provided with a fixing hole, and the fixing element and the fixing hole cooperate to fix the light guide plate on the substrate.

The backlight module further comprises at least one optical film, and the optical film is located close to a surface of the diffuser away from the light guide plate.

A range of the predetermined distance is 5 mm-20 mm.

The illuminating surface of the light guide plate is provided with micro structures, and the micro structures are employed to diffuse the light emitted from the illuminating surface of the light guide plate.

The present invention further provides a liquid crystal display device. The liquid crystal display device comprises any one of the aforesaid backlight modules.

In comparison with prior art, in the backlight module and the liquid crystal display device having the backlight module according to the present invention, because the backlight module comprises at least two light guide plates, and the light guide plates are located at the same surface of the substrate, and a tilted angle is formed between each light guide plate and the substrate, and the light source is located close to the first lateral surface of the light guide plate. Therefore, as long as a plurality of light guide plates and a plurality of light sources corresponding to the plurality of light guide plates are provided, the scale of the backlight module can be large enough for satisfying the large scale requirement, and the light emitted from the backlight module is more uniform. Furthermore, a predetermined distance is set between the diffuser and a part of the light guide plate which is closest to the diffuser adjacent thereto. Thus, the light emitted from the illuminating surface of the light guide plate adjacent thereto can be mixed to be more uniform. Accordingly, the liquid crystal display device can possess higher display quality.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structural diagram of a preferred embodiment according to a backlight module of the present invention.

FIG. 2 is a top view diagram of a preferred embodiment according to a backlight module of the present invention.

FIG. 3 is a structural diagram of a preferred embodiment according to a liquid crystal display device of the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

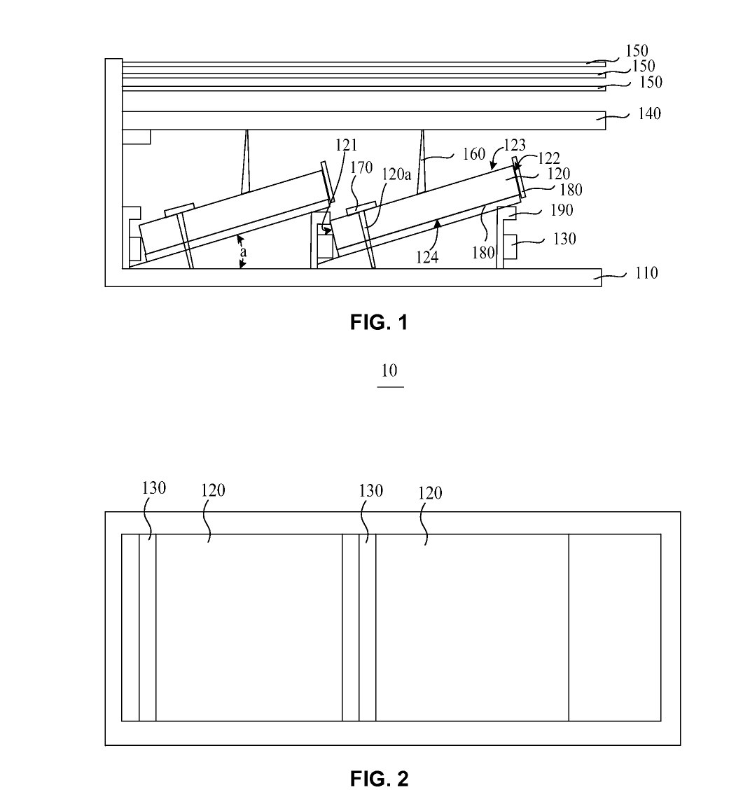

Please refer to FIG. 1 and FIG. 2 together. FIG. 1 is a structural diagram of a preferred embodiment according to a backlight module of the present invention; FIG. 2 is a top view diagram of a preferred embodiment according to a backlight module of the present invention. The backlight module 10 comprises a substrate 110, at least two light guide plate 120, a light source 130 and a diffuser 140. The light guide plates 120 are located at the same surface of the substrate 110, and tilted angles a are formed between the light guide plates 120 and the substrate 110, and the light guide plate 120 comprises a first lateral surface 121, a second lateral surface 122, an illuminating surface 123 and a bottom surface 124. The first lateral surface 121 and the second lateral surface 122 are oppositely located, and the illuminating surface 123 and the bottom surface 124 are oppositely located, and the illuminating surface 123 and the bottom surface 124 are respectively intersect with the first lateral surface 121 and the second lateral surface 122. In other words, the illuminating surface 123 is respectively intersect with the first lateral surface 121 and the second lateral surface 122, and the bottom surface 124 is respectively intersect with the first lateral surface 121 and the second lateral surface 122. The first lateral surface 121 is located close to the light source 130 to be an incident surface of the light guide plate 120. The diffuser 140 is located close to the illuminating surface 123 of the light guide plate 120, and a predetermined distance is set between the diffuser 140 and a part of the light guide plate 120 which is closest to the diffuser 140 adjacent thereto. By setting the predetermined distance between the diffuser 140 and a part of the light guide plate 120 which is closest to the diffuser 140 adjacent thereto, the light emitted from the illuminating surface 123 of the light guide plate 120 adjacent thereto can be mixed to be more uniform to prevent that the uneven brightness among the various light guide plates 120, and thus, a more uniform flat light source can be provided to the liquid crystal display panel. Preferably, a range of the predetermined distance is 5 mm-20 mm.

The light guide plate 120 can be a normal printed light guide plate. Preferably, the illuminating surface 123 of the light guide plate 120 is provided with micro structures, and the micro structures are employed to diffuse the light emitted from the illuminating surface 123 of the light guide plate 120 to make the light emitted from the illuminating surface 123 of the light guide plate 120 more uniform. Preferably, an overlapping range with a predetermined distance is set between adjacent light guide plates 120 to make no edge dark region between the adjacent light guide plates 120.

Preferably, the light source 130 is adjacent to one end of the light guide plate 120, which is farer to the diffuser 140. The light source 130 comprises a light emitting diode or a quantum dot fluorescent tube. The quantum dot fluorescent tube can be consisted of blue light emitting diode and glass packaging the quantum dot phosphor.

The backlight module 10 further comprises a reflective sheet 180, and the reflective sheet 180 is located close to the bottom surface 124 and the second lateral surface 122 of the light guide plate 120. After the light emitted from the light source 130 enters the light guide plate 120, it will exit from the second lateral surface 122, the illuminating surface 123 and the bottom surface 124 of the light guide plate 120. The light exiting from the second lateral surface 122 and the illuminating surface 123 of the light guide plate 120 will make the intensity of the light outgoing from the illuminating surface 123 weaker. Therefore, the reflective sheets 180 located at the second lateral surface 122 and the bottom surface 124 of the light guide plate 120 can reflect the light outgoing from the bottom surface 1124 and the second lateral surface 122 back into the light guide plate 120. Accordingly, the intensity of the reflected back light outgoing from the illuminating surface 123 of the light guide plate 120 is increased. Preferably, the reflective sheets 180 are located adjacent to the second lateral surface 122 and the bottom surface 124 of the light guide plate 120. The reflective sheet 180 covers the bottom surface 124 of the light guide plate 120 and contact with the bottom surface 124 to prevent the loss of the light due to that the light exiting from the bottom surface 124 of the light guide plate 120 passes through a gap before being reflected by the reflective sheet 180 back into the light guide plate 120; the reflective sheet 180 covers the second lateral surface 122 of the light guide plate 120 and contact with the second lateral surface 122 to prevent the loss of the light due to that the light exiting from the second lateral surface 122 of the light guide plate 120 passes through a gap before being reflected by the reflective sheet 180 back into the light guide plate 120. It is understandable that in other embodiments, the reflective sheet 180 can be only located close to the bottom surface 124 of the light guide plate 120. Preferably, the reflective sheet 180 covers the bottom surface 124 of the light guide plate 120 and contact with the bottom surface 124 to prevent the loss of the light due to that the light exiting from the bottom surface 124 of the light guide plate 120 passes through a gap before being reflected by the reflective sheet 180 back into the light guide plate 120. In other embodiments, the reflective sheet 180 can be only located close to the second lateral surface 122 of the light guide plate 120. Preferably, the reflective sheet 180 covers the second lateral surface 122 of the light guide plate 120 and contact with the second lateral surface 122 to prevent the loss of the light due to that the light exiting from the second lateral surface 122 of the light guide plate 120 passes through a gap before being reflected by the reflective sheet 180 back into the light guide plate 120.

The backlight module 10 further comprises a light source support part 190, and the light source support part 190 is employed to support the light source 130, and the light source support part 190 is located in an accommodation space formed by the light guide plate 120 and the substrate 110. Preferably, the light source support part 190 and the substrate 110 contact with each other to make the substrate 110 support the light source support part 190. An included angle is between the light source support part 190 and the light guide plate 120 to form included angle between the light source 130 and the light guide plate 120. The light emitted from the light source 130 can better be reflected by the reflective sheet 180 adjacent to the bottom surface 124 and exit from the illuminating surface 123.

The backlight module 10 further comprises a support element 160, and the support element 160 is located between the illuminating surface 123 of the light guide plate 120 and the diffuser 140, and the support element 160 is employed to support the diffuser 140. Preferably, the support element 160 is transparent to reduce the loss of the light emitted from the illuminating surface 123 of the light guide plate 120.

The backlight module 10 further comprises a fixing element 170, and the light guide plate 120 is provided with a fixing hole 120a, and the fixing element 170 and the fixing hole 120a cooperate to fix the light guide plate 120 on the substrate 110. In this embodiment, the fixing element 170 can be a screw nail. Correspondingly, the fixing hole 120a is a screw hole. It is understandable that the fixing element 170 and the fixing hole 120a are not merely restricted to be the screw nail and the screw hole as long as the fixing element 170 and the fixing hole 120a can cooperate to fix the light guide plate 120 on the substrate 110. With the fixing element 170 and the fixing hole 120a to fix the light guide plate 120, it can prevent the looseness of the light guide plate 120, and promote the light coupling efficiency between the light source 130 and the light guide plate 120.

The backlight module 10 further comprises at least one optical film 150, and the optical film 150 is located close to a surface of the diffuser 140 adjacent to the light guide plate 120. The optical film 150 can be but not limited to be a brightness enhancement film. The optical film 150 is employed to uniform the light emitted from the diffuser 140.

In comparison with prior art, the backlight module 10 according to the present invention comprises at least two light guide plates 120, and the light guide plates 120 are located at the same surface of the substrate 110, and a tilted angle is formed between each light guide plate 120 and the substrate 110, and the light source 130 is located close to the first lateral surface 121 of the light guide plate 120. Therefore, as long as a plurality of light guide plates 120 and a plurality of light sources 130 corresponding to the plurality of light guide plates 120 are provided, the scale of the backlight module 10 can be large enough for satisfying the large scale requirement, and the light emitted from the backlight module 10 is more uniform. Furthermore, a predetermined distance is set between the diffuser 140 and a part of the light guide plate 120 which is closest to the diffuser 140 adjacent thereto. Thus, the light emitted from the illuminating surface 124 of the light guide plate 120 adjacent thereto can be mixed to be more uniform.

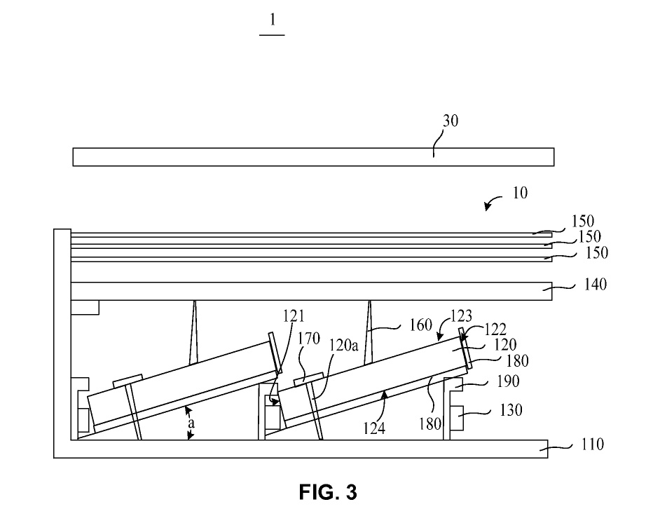

With combination of FIG. 1 and FIG. 2, the liquid crystal display device according to the present invention is introduced below. Please refer to FIG. 3, together. FIG. 3 is a structural diagram of a preferred embodiment according to a liquid crystal display device of the present invention. The liquid crystal display device 1 comprises the backlight module 10 and a liquid crystal display panel 30. The backlight module 10 and the liquid crystal display panel 30 stack-up. The backlight module 10 is employed to provide a flat light source for the liquid crystal display panel 30.

The backlight module 10 comprises a substrate 110, at least two light guide plate 120, a light source 130 and a diffuser 140. The light guide plates 120 are located at the same surface of the substrate 110, and tilted angles a are formed between the light guide plates 120 and the substrate 110, and the light guide plate 120 comprises a first lateral surface 121, a second lateral surface 122, an illuminating surface 123 and a bottom surface 124. The first lateral surface 121 and the second lateral surface 122 are oppositely located, and the illuminating surface 123 and the bottom surface 124 are oppositely located, and the illuminating surface 123 and the bottom surface 124 are respectively intersect with the first lateral surface 121 and the second lateral surface 122. In other words, the illuminating surface 123 is respectively intersect with the first lateral surface 121 and the second lateral surface 122, and the bottom surface 124 is respectively intersect with the first lateral surface 121 and the second lateral surface 122. The first lateral surface 121 is located close to the light source 130 to be an incident surface of the light guide plate 120. The diffuser 140 is located close to the illuminating surface 123 of the light guide plate 120, and a predetermined distance is set between the diffuser 140 and a part of the light guide plate 120 which is closest to the diffuser 140 adjacent thereto. By setting the predetermined distance between the diffuser 140 and a part of the light guide plate 120 which is closest to the diffuser 140 adjacent thereto, the light emitted from the illuminating surface 123 of the light guide plate 120 adjacent thereto can be mixed to be more uniform to prevent that the uneven brightness among the various light guide plates 120, and thus, a more uniform flat light source can be provided to the liquid crystal display panel. Preferably, a range of the predetermined distance is 5 mm-20 mm.

The light guide plate 120 can be a normal printed light guide plate. Preferably, the illuminating surface 123 of the light guide plate 120 is provided with micro structures, and the micro structures are employed to diffuse the light emitted from the illuminating surface 123 of the light guide plate 120 to make the light emitted from the illuminating surface 123 of the light guide plate 120 more uniform. Preferably, an overlapping range with a predetermined distance is set between adjacent light guide plates 120 to make no edge dark region between the adjacent light guide plates 120.

Preferably, the light source 130 is adjacent to one end of the light guide plate 120, which is farer to the diffuser 140. The light source 130 comprises a light emitting diode or a quantum dot fluorescent tube. The quantum dot fluorescent tube can be consisted of blue light emitting diode and glass packaging the quantum dot phosphor.

The backlight module 10 further comprises a reflective sheet 180, and the reflective sheet 180 is located close to the bottom surface 124 and the second lateral surface 122 of the light guide plate 120. After the light emitted from the light source 130 enters the light guide plate 120, it will exit from the second lateral surface 122, the illuminating surface 123 and the bottom surface 124 of the light guide plate 120. The light exiting from the second lateral surface 122 and the illuminating surface 123 of the light guide plate 120 will make the intensity of the light outgoing from the illuminating surface 123 weaker. Therefore, the reflective sheets 180 located at the second lateral surface 122 and the bottom surface 124 of the light guide plate 120 can reflect the light outgoing from the bottom surface 1124 and the second lateral surface 122 back into the light guide plate 120. Accordingly, the intensity of the reflected back light outgoing from the illuminating surface 123 of the light guide plate 120 is increased. Preferably, the reflective sheets 180 are located adjacent to the second lateral surface 122 and the bottom surface 124 of the light guide plate 120. The reflective sheet 180 covers the bottom surface 124 of the light guide plate 120 and contact with the bottom surface 124 to prevent the loss of the light due to that the light exiting from the bottom surface 124 of the light guide plate 120 passes through a gap before being reflected by the reflective sheet 180 back into the light guide plate 120; the reflective sheet 180 covers the second lateral surface 122 of the light guide plate 120 and contact with the second lateral surface 122 to prevent the loss of the light due to that the light exiting from the second lateral surface 122 of the light guide plate 120 passes through a gap before being reflected by the reflective sheet 180 back into the light guide plate 120. It is understandable that in other embodiments, the reflective sheet 180 can be only located close to the bottom surface 124 of the light guide plate 120. Preferably, the reflective sheet 180 covers the bottom surface 124 of the light guide plate 120 and contact with the bottom surface 124 to prevent the loss of the light due to that the light exiting from the bottom surface 124 of the light guide plate 120 passes through a gap before being reflected by the reflective sheet 180 back into the light guide plate 120. In other embodiments, the reflective sheet 180 can be only located close to the second lateral surface 122 of the light guide plate 120. Preferably, the reflective sheet 180 covers the second lateral surface 122 of the light guide plate 120 and contact with the second lateral surface 122 to prevent the loss of the light due to that the light exiting from the second lateral surface 122 of the light guide plate 120 passes through a gap before being reflected by the reflective sheet 180 back into the light guide plate 120.

The backlight module 10 further comprises a light source support part 190, and the light source support part 190 is employed to support the light source 130, and the light source support part 190 is located in an accommodation space formed by the light guide plate 120 and the substrate 110. Preferably, the light source support part 190 and the substrate 110 contact with each other to make the substrate 110 support the light source support part 190. An included angle is between the light source support part 190 and the light guide plate 120 to form included angle between the light source 130 and the light guide plate 120. The light emitted from the light source 130 can better be reflected by the reflective sheet 180 adjacent to the bottom surface 124 and exit from the illuminating surface 123.

The backlight module 10 further comprises a support element 160, and the support element 160 is located between the illuminating surface 123 of the light guide plate 120 and the diffuser 140, and the support element 160 is employed to support the diffuser 140. Preferably, the support element 160 is transparent to reduce the loss of the light emitted from the illuminating surface 123 of the light guide plate 120.

The backlight module 10 further comprises a fixing element 170, and the light guide plate 120 is provided with a fixing hole 120a, and the fixing element 170 and the fixing hole 120a cooperate to fix the light guide plate 120 on the substrate 110. In this embodiment, the fixing element 170 can be a screw nail. Correspondingly, the fixing hole 120a is a screw hole. It is understandable that the fixing element 170 and the fixing hole 120a are not merely restricted to be the screw nail and the screw hole as long as the fixing element 170 and the fixing hole 120a can cooperate to fix the light guide plate 120 on the substrate 110. With the fixing element 170 and the fixing hole 120a to fix the light guide plate 120, it can prevent the looseness of the light guide plate 120, and promote the light coupling efficiency between the light source 130 and the light guide plate 120.

The backlight module 10 further comprises at least one optical film 150, and the optical film 150 is located close to a surface of the diffuser 140 adjacent to the light guide plate 120. The optical film 150 can be but not limited to be a brightness enhancement film. The optical film 150 is employed to uniform the light emitted from the diffuser 140.

The liquid crystal display panel 30 is located close to one side of the optical film 150 away from the diffuser 140 to work in the light provided by the backlight module 10.

In comparison with prior art, the backlight module 10 in the liquid crystal display device 1 according to the present invention comprises at least two light guide plates 120, and the light guide plates 120 are located at the same surface of the substrate 110, and a tilted angle is formed between each light guide plate 120 and the substrate 110, and the light source 130 is located close to the first lateral surface 121 of the light guide plate 120. Therefore, as long as a plurality of light guide plates 120 and a plurality of light sources 130 corresponding to the plurality of light guide plates 120 are provided, the scale of the backlight module 10 can be large enough for satisfying the large scale requirement, and the light emitted from the backlight module 10 is more uniform. Furthermore, a predetermined distance is set between the diffuser 140 and a part of the light guide plate 120 which is closest to the diffuser 140 adjacent thereto. Thus, the light emitted from the illuminating surface 124 of the light guide plate 120 adjacent thereto can be mixed to be more uniform. Accordingly, the liquid crystal display device 1 can possess higher display quality.

Above are embodiments of the present invention, which does not limit the scope of the present invention. Any modifications, equivalent replacements or improvements within the spirit and principles of the embodiment described above should be covered by the protected scope of the invention.

What is claimed is:

1. A backlight module, wherein the backlight module comprises a substrate, at least two light guide plate, a light source and a diffuser, and the light guide plates are located at the same surface of the substrate, and tilted angles are formed between the light guide plates and the substrate, and the light guide plate comprises a first lateral surface, a second lateral surface, an illuminating surface and a bottom surface, and the first lateral surface and the second lateral surface are oppositely located, and the illuminating surface and the bottom surface are oppositely located, and the illuminating surface and the bottom surface are respectively intersect with the first lateral surface and the second lateral surface, and the first lateral surface is located close to the light source to be an incident surface of the light guide plate, and the diffuser is located close to the illuminating surface of the light guide plate, and a predetermined distance is set between the diffuser and a part of the light guide plate which is closest to the diffuser adjacent thereto.

2. The backlight module according to claim 1, wherein the backlight module further comprises a reflective sheet, and the reflective sheet is located close to the bottom surface and the second lateral surface of the light guide plate.

3. The backlight module according to claim 1, wherein the backlight module further comprises a light source support part, and the light source support part is employed to support the light source, and the light source support part is located in an accommodation space formed by the light guide plate and the substrate.

4. The backlight module according to claim 1, wherein the backlight module further comprises a support element, and the support element is located between the illuminating surface of the light guide plate and the diffuser, and the support element is employed to support the diffuser.

5. The backlight module according to claim 1, wherein the backlight module further comprises a fixing element, and the light guide plate is provided with a fixing hole, and the fixing element and the fixing hole cooperate to fix the light guide plate on the substrate.

6. The backlight module according to claim 1, wherein the backlight module further comprises at least one optical film, and the optical film is located close to a surface of the diffuser away from the light guide plate.

7. The backlight module according to claim 1, wherein a range of the predetermined distance is 5 mm-20 mm.

8. The backlight module according to claim 1, wherein the illuminating surface of the light guide plate is provided with micro structures, and the micro structures are employed to diffuse the light emitted from the illuminating surface of the light guide plate.

9. The backlight module according to claim 1, wherein the light source comprises a light emitting diode or a quantum dot fluorescent tube.

10. A liquid crystal display device, wherein the liquid crystal display device comprises a backlight module, and the backlight module comprises a substrate, at least two light guide plate, a light source and a diffuser, and the light guide plates are located at the same surface of the substrate, and tilted angles are formed between the light guide plates and the substrate, and the light guide plate comprises a first lateral surface, a second lateral surface, an illuminating surface and a bottom surface, and the first lateral surface and the second lateral surface are oppositely located, and the illuminating surface and the bottom surface are oppositely located, and the illuminating surface and the bottom surface are respectively intersect with the first lateral surface and the second lateral surface, and the first lateral surface is located close to the light source to be an incident surface of the light guide plate, and the diffuser is located close to the illuminating surface of the light guide plate, and a predetermined distance is set between the diffuser and a part of the light guide plate which is closest to the diffuser adjacent thereto.

11. The liquid crystal display device according to claim 10, wherein the backlight module further comprises a reflective sheet, and the reflective sheet is located close to the bottom surface and the second lateral surface of the light guide plate.

12. The liquid crystal display device according to claim 10, wherein the backlight module further comprises a light source support part, and the light source support part is employed to support the light source, and the light source support part is located in an accommodation space formed by the light guide plate and the substrate.

13. The liquid crystal display device according to claim 10, wherein the backlight module further comprises a support element, and the support element is located between the illuminating surface of the light guide plate and the diffuser, and the support element is employed to support the diffuser.

14. The liquid crystal display device according to claim 10, wherein the backlight module further comprises a fixing element, and the light guide plate is provided with a fixing hole, and the fixing element and the fixing hole cooperate to fix the light guide plate on the substrate.

15. The liquid crystal display device according to claim 10, wherein the backlight module further comprises at least one optical film, and the optical film is located close to a surface of the diffuser away from the light guide plate.

16. The liquid crystal display device according to claim 10, wherein a range of the predetermined distance is 5 mm-20 mm.

17. The liquid crystal display device according to claim 10, wherein the illuminating surface of the light guide plate is provided with micro structures, and the micro structures are employed to diffuse the light emitted from the illuminating surface of the light guide plate.

18. The liquid crystal display device according to claim 10, wherein the light source comprises a light emitting diode or a quantum dot fluorescent tube.
